(19) United States
(12) Patent Application Publication
(10) Pub. No.: US 2024/0320067 A1
(43) Pub. Date: Sep. 26, 2024

(54) EXECUTION OF AN APPLICATION USING BUFFERS

(71) Applicant: International Business Machines Corporation, Armonk, NY (US)

(72) Inventors: Philipp Göttlich, Nufringen (DE); Knut Stolze, Hummelshain (DE); Max Fabian Gilbert, Ludwigshafen am Rhein (DE)

(21) Appl. No.: 18/307,909

(22) Filed: Apr. 27, 2023

(30) Foreign Application Priority Data
Mar. 20, 2023 (GB) 2304003.3

(51) Int. Cl. G06F 9/54; G06F 11/36

(52) U.S. Cl. CPC G06F 9/544; G06F 11/3644

(57) ABSTRACT

The present disclosure relates to a method for execution of an application comprising a sequence of components. The first component is configured to store output data in an unused buffer and each subsequent component is configured to use a buffer comprising an output provided by the component preceding said subsequent component. The method comprises: providing a set of buffer states representing different contents of the buffer respectively, the set of buffer states comprising an initial state representing a content of the unused buffer and subsequent states representing the outputs of the sequence of components respectively. The buffer states may be sorted, wherein the sorting is circular so that a final state is followed by the initial state. During execution of the application a current state of a buffer may be changed to a subsequent state in case the current application component using the buffer finishes.

### BACKGROUND OF THE INVENTION

The present invention relates to the field of digital computer systems, and more specifically, to a method for execution of an application using buffers.

Buffers are used across the board in many different software products, e.g., as caches for database systems or as intermediate storage for data stream processing to balance different producer and receiver speeds. These buffers have to be managed. However, managing buffers in a software product may be a difficult task.

### SUMMARY

Various embodiments provide a method for execution of an application using buffers, computer program product and computer system as described by the subject matter of the independent claims. Advantageous embodiments are described in the dependent claims. Embodiments of the present invention can be freely combined with each other if they are not mutually exclusive.

In one aspect, the invention relates to a method for execution of an application using buffers, the application comprising a sequence of components, the first component of the sequence being configured to store output data in an unused buffer, each subsequent component of the sequence being configured to use a buffer comprising an output provided by the component preceding said subsequent component. The method comprises: providing a set of buffer states representing different contents of the buffer respectively, the set of buffer states comprising an initial state representing a content of the unused buffer and subsequent states representing the outputs of the sequence of components respectively, wherein the application component is configured to use the buffer in case the buffer is in the state representing the output required by the application component; sorting the buffer states in order of the sequence of components, wherein the sorting is circular so that a final state is followed by the initial state; assigning to the buffers the initial state before execution of the application; repeatedly executing the application; changing during execution of the application a current state of a buffer of the buffers to a subsequent state in case a transition condition is fulfilled, wherein the transition condition requires that the current application component using the buffer finishes.

In one aspect the invention relates to a computer program product comprising a computer-readable storage medium having computer-readable program code embodied therewith, the computer-readable program code configured to implement the method of the above embodiment.

In one aspect the invention relates to a computer system for execution of an application, the computer system comprising buffers, the application comprising a sequence of components, the first component of the sequence being configured to store output data in an unused buffer, each subsequent component of the sequence being configured to use a buffer comprising an output provided by the component preceding said subsequent component. The computer system is configured for: providing a set of buffer states representing different contents of the buffer respectively, the set of buffer states comprising an initial state representing a content of the unused buffer and subsequent states representing the outputs of the sequence of components respectively, wherein the application component is configured to use the buffer in case the buffer is in the state representing the output required by the application component; sorting the buffer states in order of the sequence of components, wherein the sorting is circular so that a final state is followed by the initial state; assigning to the buffers the initial state before execution of the application; repeatedly executing the application; changing during execution of the application a current state of a buffer of the buffers to a subsequent state in case a transition condition is fulfilled, wherein the transition condition requires that the current application component using the buffer finishes.

### BRIEF DESCRIPTION OF THE SEVERAL VIEWS OF THE DRAWINGS

In the following embodiments of the invention are explained in greater detail, by way of example only, making reference to the drawings in which:

FIG. 1 is a block diagram of a computer system in accordance with an example of the present subject matter.

FIG. 2 is a flowchart of a method for execution of an application using buffers in accordance with an example of the present subject matter.

FIG. 3 is a flowchart of a method for execution of an application component in accordance with an example of the present subject matter.

FIG. 4 is a flowchart of a method for execution of an application in accordance with an example of the present subject matter.

FIG. 5 is a diagram illustrating state changes and movement of iterators in accordance with an example of the present subject matter.

FIG. 6 is a diagram illustrating state changes and movement of iterators in accordance with an example of the present subject matter.

FIG. 7 is a computing environment in accordance with an example of the present subject matter.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

An application may be provided e.g., for performing a task. The task may, for example, be management of a database, monitoring a system or processing of streaming data. The application may comprise a set of instructions, that when executed, the task is performed. The task may, for example, be a composite task comprising a sequence of subtasks that may be performed in a defined order so that the output of a subtask becomes the input of the following subtask, wherein the last subtask may provide the result of the task. The set instructions may comprise a sequence of subsets of instructions for performing the subtasks respectively. For example, the application may comprise application components for performing the sequence of subtasks respectively, wherein the application components comprise the subsets of instructions respectively. The sequence of application components may comprise a number N components which may be referred to as comp₁, . . . , comp_{N}, where the number of components is higher than or equal to two, N≥2.

The application components may interface with each other so that the output of an application component is used as input for the application component that follows, wherein the last component may provide the result of the application. The interfacing may, for example, be implemented by a set of buffers. The buffers may be used to temporarily store the outputs of the application components. This may enable an indirect transfer of outputs between the application components. The buffer may be an allocation of memory of a certain size that is operable to store data. The buffer may be a region of a main memory used to temporarily store data while it is being moved from one place to another. The buffer may enable a fast access to data. The buffer may be available if it is not being used or processed by an application component e.g., the available buffer may be a buffer having data but none of the application components is accessing the buffer. The application component processes a buffer means that the application component reads data from and/or write data into the buffer. In one example, more than one instance of the same application component may be concurrently processing respective buffers.

The set of buffers may, for example, be used to store the outputs of the application components. For example, the first application component comp₁ of the sequence of application components may require an unused buffer. The unused buffer may be an available buffer that is not being used by any of the application components. For example, an unused buffer may be an empty buffer or an available buffer comprising old or outdated data. The first application component comp₁ may store its output (out₁) in one or more buffers of the set of buffers. The second application component comp₂ may use the buffer to process that output out₁ and stores its output out₂ in that buffer and so on. The last component comp_{N} may use the buffer to process the output out_{N-1} provided by the second last component comp_{N-1} in order to provide the result of the task e.g., to a user. That is, the last component comp_{N} may not write an output in the buffer.

The present subject matter may advantageously use the set of buffers to efficiently implement the application. For that, a set of buffer states (which may be referred to as states) for tagging the set of buffers may be provided. The set of buffer states may facilitate access to the set of buffers. The set of buffer states may comprise a number K of states which may be referred to as State₀ through State_{K} respectively, where K≥1. The buffer state which is currently assigned to a buffer may indicate the content of that buffer. The set of buffer states comprises an initial state State₀ that indicates the content of an unused buffer. That is, if a buffer is assigned the initial state State₀, this indicates that the buffer is an unused buffer. The set of buffer states State₁ through State_{K} (subsequent to the initial state) may comprise states representing the outputs of the sequence of components comp₁ through comp_{N} respectively. For example, the state State₁ may indicate the output out₁. That is, if a buffer is assigned the state State₁, this indicates that the buffer stores an output of the first application component comp₁. For example, the state State₂ may indicate the output out₂. That is, if a buffer is assigned the state State₂, this indicates that the buffer stores an output of the second application component comp₂. In general, each subsequent state Stateₖ represents the output of the component compₖ, where k is a positive integer, 1≤k≤K. The buffer state may be referred to as a processing state because it also indicates the process that can use the buffer, e.g., the subsequent Stateₖ may be a processing state associated with the component compₖ₊₁ because the component compₖ₊₁ is configured to process buffers in the state Stateₖ.

The set of buffer states may be sorted following the order of the sequence of components. That is, the initial state State₀ is followed by the state State₁, the state State₁ is followed by State₂ and so on, to obtain the following order: State₀→State₁ . . . →State_{K}. In addition, the sorting may be circular so that the final state is followed by the initial state: State_{K}→State₀.

The application components may be controlled to access the set of buffers using the buffer states assigned to the buffers. In particular, each application component may only access buffers with a specific state. For example, each application component compᵢ, where i varies between 1 and N, may process the buffers having the state Stateᵢ₋₁. For example, since the first application component comp₁ requires an unused buffer, the first application component comp₁ may only process the buffers having the initial state State₀ which indicates the unused buffer. The second application component comp₂ may require the output out₁ which is represented by the state State₁ and thus may only process the buffers having the state State₁ and so on. The execution of each application component compᵢ of the application may comprise a step of searching one or more buffers that have the state Stateᵢ₋₁ required by the application component compᵢ, and thereafter performing the respective subtask using the data in the found buffer. If no buffer is found in the state Stateᵢ₋₁ required by the application component compᵢ, the application component compᵢ may wait until a buffer is in that state Stateᵢ₋₁.

Before execution of the application, the buffers may be assigned the initial state State₀ respectively. This indicates that all buffers are currently unused buffers. After initialization, the application may be executed. The execution of the application may, for example, be repeatedly performed e.g., the application is executed again and again for processing streaming data or monitoring a system. The states of the buffers may automatically be changed during execution of the application. During execution of the application, a current state Stateᵢ₋₁ of a buffer X of the buffers may be changed to the following state Stateᵢ if a transition condition is fulfilled. Buffer X may be any buffer of the set of buffers. The transition condition may require that the current application component compᵢ using the buffer X finishes. Saying that the state Stateᵢ₋₁ of a buffer is changed to the subsequence state Stateᵢ may be equivalent to say that the buffer transitioned to the state Stateᵢ.

It may happen that during execution of the application, that one or more subsets of the set of buffers may each be in the same state. In this case, a distinction may be made between the buffers of each subset based on the time at which they transitioned to that same state. For example, if a subset of buffers have the state Stateᵢ₋₁, they may be ranked according to the time at which they transitioned to the state Stateᵢ₋₁, e.g., the earliest buffer that transitioned to the state Stateᵢ₋₁ may first be ranked and the latest buffer that transitioned to the state Stateᵢ₋₁ may be last ranked. In case the application component compᵢ is to be executed, then the earliest buffer that transitioned to the state Stateᵢ₋₁ may first be used by the application component compᵢ, then followed by the second buffer and so on.

The present subject matter may be advantageous for the following reasons. The buffer states may preserve the processing order of the set of buffers within the whole processing chain of the application. This may increase robustness, safety, efficiency and reduce the need for additional safeguards and instructions, saving computation resources. The present subject matter may tenable an asynchronous handling of the buffers which may reduce dependencies between components drastically and increase the robustness of the software system. In particular, the sequence of buffer working steps may be preserved automatically by the buffer states, waiting times may be reduced in comparison to synchronous approaches. A variable number of buffers and buffer sizes may be easier to realize. With the present method, it is clear which job in the processing order is allowed to handle the buffer next or if it's just kept alive for information persistency, without additional synchronization or checks may be needed. The present subject may provide a robust and efficient stream buffer manager structure with free integrated flight recorder for information conservation.

The number of buffer states (i.e., K+1) may be equal to the number of application components, that is K=N−1. Alternatively, the number of buffer states may be higher than the number of application components e.g., the number of buffer states may be the number of application components plus one, that is K=N.

According to one example, in case the number of buffer states is equal to the number of application components, the final state State_{K} represents the output out_{N-1} of the second last component comp_{N-1} of the sequence. After the component comp_{N} finishes the processing of the buffer in state State_{N-1}, the state State_{N-1} may be changed to the initial state State₀.

According to one example, in case the number of buffer states is the number of application components plus one (i.e., K=N), the final state State_{K} represents the output out_{N-1} of the second last component comp_{N-1} of the sequence after the last component comp_{N} of the sequence finishes. That is, the two last states State_{K-1} and State_{K} may represent the same output of the second last component comp_{N-1}. In this case, the final state State_{K} may be referred to as “keep-alive state”. For example, the content of the buffer in state State_{K}_₁ is the same as in state State_{K}, the only difference is that the buffer in state State_{K-1} is used by component comp_{K} to provide the results of the task, while the buffer in state State_{K} is used (e.g., also by component comp_{K}) but for a different purpose e.g., for debugging purpose. For example, the last component comp_{N}² may comprise a sub component comp_{N}¹ followed by a second sub component comp_{N}². The sub component comp_{N}¹ may use the output out_{N-1} of the second last component comp_{N-1} to provide a result of the task. For that, the sub component comp_{N}¹ may process the buffer with state State_{N-1}. The sub component comp_{N} may maintain (or keep a live) the output out_{N-1} in the buffer for a certain time period, wherein the buffer is in state State_{N}. After that period, the sub component comp_{N} or the first component comp₁ may change the state State_{N} to the initial state State₀.

An advantage of the present example may be the seamless integration of information conservation without additional overhead. By setting a specific state at the end of a buffer's lifetime, e.g., ‘keep alive until reuse’, it may always be possible to access the last data, which were handled by the buffer. This may give the option of collecting information for debugging and tracing without the overhead of data copy, extra memory allocations or the execution of additional instructions. The circular structure, in which the buffer manager maintains these buffers, allows the buffer manager to keep used buffers in the ‘keep alive’ state until all other buffers have been used, without additional overhead. Simply scaling up the total number of buffers can be used to increase the number of buffers kept in ‘keep alive’ state. The information persistence (flight recorder) may not cost additional computation resources because of using states and a circular internal structure of the manager and enables to save the transported buffer data for free e.g., for informational or debugging purposes.

According to one example, in case the number of buffer states is the number of application components plus one (i.e., K=N) and the current state is the final state State_{K}, the transition condition further requires that the buffer having the final state State_{K} is the first buffer of a number J of buffers having the final state State_{K}. This example may first check the number buffers having the final state State_{K}. If the number of buffers is smaller than the number J, the buffer state of the current does not change. If the number of buffers is higher than or equal to J, it may be determined whether the current buffer is the earliest buffer of the found buffers having the final state State_{K}. This example may enable that a minimum number J−1 of buffers are present in the final state State_{K}. This may provide sufficient data for debugging.

According to one example, in case the number of buffer states is the number of application components plus one and the current state is the final state, the transition condition further requires that the buffer having the current state remains in that final state for a minimum period of time or remains in that final state until it reaches a maximum size.

This may have the advantage, that buffers are kept alive as long as possible, preserving their information, which may be needed for tracing and debugging, without the overhead of data copying, memory allocation or additional processing steps, as other state-of-the-art approaches have.

According to one example, the method comprises, in case the number of buffer states is the number of application components plus one a debugging using data stored in the buffers having the final state State_{K} may be performed.

According to one example, the changing of the current state Stateᵢ₋₁ of the buffer X is performed by the current application component compᵢ using the buffer X.

The present subject matter may use an efficient means such as data structures to identify buffers that can be processed by application components following the circular order of the buffer states. According to one example, executing the application component compᵢ comprises: receiving by a buffer manager from the application component compᵢ a request of a buffer state Stateᵢ₋₁ representing the output required by said application component compᵢ. The buffer manager may determine whether an available buffer is in the requested state Stateᵢ₋₁ and if so, the buffer manager may send an indication of the available buffer to the requesting application component compᵢ which processes the available buffer to perform the subtask associated with the application component compᵢ. In case there is no available buffer in the state Stateᵢ₋₁, the buffer manager may identify the oldest/earliest buffer that transitioned to a selected previous state and may send an indication of the identified buffer to the requesting application component compᵢ which may wait until the state of identified buffer changes to the state Stateᵢ₋₁ and then processes the buffer for performing the subtask. The selected previous state may be the state of an available buffer, which is the closest state to the state Stateᵢ₋₁ following the order e.g., if the buffers in states Stateᵢ₋₂ and Stateᵢ₋₄ are available, the selected previous state is Stateᵢ₋₂, and if the buffers in states Stateᵢ₋₃, Stateᵢ₋₄ and Stateᵢ₋₅ are available, the selected previous state is Stateᵢ₋₃. an iterator pointing on a suitable buffer—namely the next buffer in the requested state or, if none available, the buffer which reaches that state next—“searching” involves computation effort, which we don't have, as the iterators move automatically during the buffer management flow.

According to one example, upon changing the state of a buffer by an application component, the application component may notify the change to all application components which are waiting for a buffer.

According to one example, the method further comprises: creating at a buffer manager a data structure comprising pointers to the buffers respectively and providing for each buffer state of the buffer states an iterator for traversing the data structure, wherein each iterator is configured to traverse the data structure elements comprising the pointers that represent the state of the iterator. During the execution of the application, the following may be performed. The pointers of the data structure may be sorted by the buffer manager in accordance with the circular order of the buffer states of the respective buffers, wherein in case more than one buffer is in the same state, the pointers of said more than one buffer may be sorted according to the time at which the buffers transitioned to said state. The iterator is assigned by the buffer manager to the pointer pointing to the earliest buffer that transitioned to the state of the iterator or if no buffer has that state of the iterator, the iterator is assigned to the pointer pointing to the first buffer that transitioned to a selected state preceding the state of the iterator. A request of a buffer state representing the output required by the application component may be received by the buffer manager. The pointer to which the iterator of the requested state is assigned may be sent to the application component by the buffer manager. In case the buffer pointed to by the received pointer has the requested buffer state, the application component may process the buffer. In case the buffer pointed to by the received pointer is the first buffer having the state preceding the requested state, the application component may wait until that buffer transitions to the requested state in order to process the buffer by the application component. The selected state preceding the state of the iterator may be the state of an available buffer, which is the closest state to the state of the iterator following the order e.g., if the state of the iterator is Stateᵢ₋₁ and the buffers in states Stateᵢ₋₂ and Stateᵢ₋₄ are available, the selected preceding state is Stateᵢ₋₂, and if the buffers in states Stateᵢ₋₃, Stateᵢ₋₄ and Stateᵢ₋₅ are available, the selected preceding state is Stateᵢ₋₃.

This example may enable a special buffer manager component which organizes buffers via states, tracked inside the individual buffers, which again are administered in a circular structure inside the manager. Components can only process buffers of a specific state, which they get over pointers from the buffer manager after a request. The buffer manager administrates all the buffers over different iterators inside the circular structure, one buffer for each possible state, to always have a buffer in a specific state ready to send out to the requesting components or to know which buffer will reach the desired state next. A component just sets a buffer to the next state when it's finished processing that buffer and no additional communication with the buffer manager is necessary. The buffer manager may only be contacted if a new buffer is needed by a component. If that happens, it will check the corresponding iterator and give out a pointer to the next buffer of the requested state or, if none available, the next buffer, which will reach that state, in which case the requesting component waits for a buffer state change.

According to one example, the method further comprises: creating a data structure comprising pointers to the buffers respectively and providing for each buffer state of the buffer states an iterator for traversing the data structure, each iterator being configured to traverse the data structure elements comprising the pointers that represent the state of the iterator. During the execution of the application the following may be performed. The pointers of the data structure may be sorted in accordance with the circular order of the buffer states of the respective buffers, wherein in case more than one buffer is in the same state, the pointers of said more than one buffer may be sorted according to the time at which the buffers transitioned to said state, wherein the iterator is assigned to the pointer pointing to the earliest buffer having the state of the iterator or if no buffer has that state of the iterator, the iterator is assigned to the pointer pointing to the first buffer having a selected state preceding the state of the iterator. A request of a buffer state representing the output required by the application component may be received by a buffer manager. In case a buffer has the requested buffer state, the pointer pointing to that buffer may be sent by the buffer manager to the application component. In case there is no buffer having the requested state, the buffer manager may wait until a buffer has the requested state in order to send the pointer to that buffer to the application component. The application component may process the buffer pointed to by the received pointer. The selected state preceding the state of the iterator may be the state of an available buffer, which is the closest state to the state of the iterator following the order e.g., if the state of the iterator is Stateᵢ₋₁ and the buffers in states Stateᵢ₋₂ and Stateᵢ₋₄ are available, the selected preceding state is Stateᵢ₋₂, and if the buffers in states Stateᵢ₋₃, Stateᵢ₋₄ and Stateᵢ₋₅ are available, the selected preceding state is Stateᵢ₋₃.

The present subject matter may enable to use an internal structure to manage the buffers for all processing components, which need to handle buffers. The buffers are kept in a circular structure and are accessed e.g., over moving iterators, which may avoid the need to add or remove buffer, like current approaches have.

According to one example, the buffer states are encoded in the respective buffers. This may enable to organize buffers via states, tracked inside the individual buffers, which again are administered in a circular structure inside the manager.

According to one example, the execution of the application is repeated until a stopping criterion is fulfilled, wherein the stopping criterion requires a maximum number of repetitions or a stopping request is received.

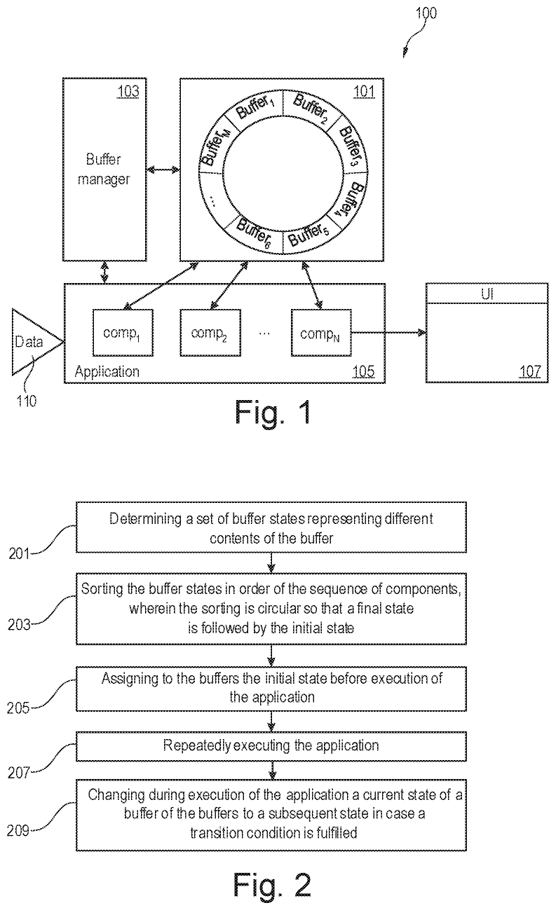

FIG. 1 is a diagram of computer system in accordance with an example of the present subject matter. The computer system 100 comprises a buffer system 101. The buffer system 101 comprises a set of M buffers Buffer₁ through Buffer_{M}. The computer system 100 further comprises a buffer manager 103 for managing access to the set of buffers Buffer₁ through Buffer_{M}. For example, the buffer manager 103 may manage access to the set of buffers Buffer₁ through Buffer_{M} by an application 105. The application 105 may comprise a sequence of components comp₁ through comp_{N}. The set of buffers Buffer₁ through Buffer_{M} may, for example, be used to store the outputs of at least part of the application components comp₁ through comp_{N}. For example, the first application component comp₁ of the sequence of application components may require an unused buffer. The unused buffer may be a buffer that is not being used by any of the application components comp₁ through comp_{N}. For example, an unused buffer may be an empty buffer or a buffer comprising old data. The first application component comp₁ may, for example, received data 110 e.g., from a data source and store it as output (out₁) in one or more buffers of the set of buffers Buffer₁ through Buffer_{M}. The second application component comp₂ may use the buffer to process that output out₁ and stores its output out₂ in that buffer and so on. The last application component of the sequence may, for example, provide the output out_{N-1} provided by the preceding application component comp_{N-1} using for example a user interface (UI) 107.

As indicated in FIG. 1, the buffer manager 103 organizes the set of buffers Buffer₁ through Buffer_{M} via states, tracked inside the individual the set of buffers Buffer₁ through Buffer_{M}, which again are administered in a circular structure inside the buffer manager 103.

FIG. 2 is a flowchart for executing an application in accordance with an example of the present subject matter. For the purpose of explanation, the method described in FIG. 2 may be implemented in the system illustrated in FIG. 1, but is not limited to this implementation.

A set of buffer states representing different contents of the buffer may be determined in step 201. The set of buffer states comprises an initial state (State₀) representing a content of the unused buffer. The set of buffer states further comprises subsequent states State₁ through State_{K}, where State_{K} is the final state. K=N−1, in case the final state represents the output of the second last component of the sequence. K=N, in case the final state represents the output of the second last component comp_{N-1} of the sequence immediately after the last component comp_{N} of the sequence finishes.

The subsequent states State₁ through State_{K} may represent the outputs of the sequence of components comp₁ through comp_{N-1} respectively. The state State_{N-1} may, for example, represent the output out_{N-1} of the second last component comp_{N-1} just preceding the last component comp_{N}. The states are defined so that the application components comp₁ through comp_{N} may be controlled to access the set of buffers Buffer₁ through Buffer_{M} using the states. For example, each application component comp₁ is configured to use an available buffer of a specific state Stateᵢ₋₁ or to wait for a buffer to become available in that specific state Stateᵢ₋₁, where i varies between 1 and N. For example, the first application component comp₁ may access only unused buffers meaning buffers which have the state State₀, the second application component comp₂ may access only buffers that store the output out₁ of the first application component, meaning buffers which have the state State₁ and so on.

The buffer states State₀ through State_{K} may be sorted in step 203. The sorting of the buffer states State₀ through State_{K} may be performed in accordance with the order of the associated sequence of components comp₁ through comp_{N}. For example, the state Stateᵢ₋₁ is associated with the component compᵢ, because that component comp₁ requires a buffer in that Stateᵢ₋₁ e.g., the state State₀ is associated with the component compₗ, because that component comp₁ requires a buffer in that State₀ etc. Thus, the states may be sorted so that Stateᵢ₋₁ is followed by State₁ e.g., as follows: State₀→State₁ . . . →State_{K}. In addition, the sorting may be circular so that the final state State_{K} is followed by the initial state State₀. That is, the present sorting may allow the following state transitions: the transitions from Stateₖ₋₁ to Stateₖ and the transition State_{K} to State₀, where k varies between 1 and K and k=i in case i≠N and K=N−1.

Before execution of the application 105, the set of buffers Buffer₁ through Buffer_{M} may be each be assigned in step 205 the initial state State₀. That is, the set of buffers Buffer₁ through Buffer_{M} may be initialized in step 205. For example, each buffer of the set of buffers Buffer₁ through Buffer_{M} may comprise an internal structure representing the state of the buffer. This internal structure may be changed to change the state of the buffer. Alternatively, the states may be managed centrally by the buffer manager 103.

The application 105 may repeatedly be executed in step 207. For example, the application 105 may be a streaming application for processing stream data. In this case, data 110 is continuously arriving in order to be processed by the application 105. Similarly, in case of a monitoring application, the data 110 may continuously be received e.g., from a source collecting the monitoring data. The processing of the received data may be performed by the sequence of components comp₁ through comp_{N} e.g., in order to provide e.g., display, by the last component comp_{N} the resulting data in a user interface 107. The execution of the application 105 on a given input data may comprise the successive execution of the application components comp₁ through comp_{N} following their order using the given input data. For each further received input data, the application components comp₁ through comp_{N} following their order using that received input data. In case different input data are received concurrently, different instances of the same application component compᵢ may process different buffers respectively.

During execution of the application 105, the states of the set of buffers Buffer₁ through Buffer_{M} may automatically be changed in step 209 as follows. The state Stateₖ₋₁ of each buffer Bufferⱼ, where j varies between 1 and M, of the set of buffers Buffer₁ through Buffer_{M} may be changed to a subsequent state Stateₖ in case a transition condition is fulfilled. For example, for transiting from Stateₖ₋₁ to Stateₖ, the transition condition requires that the current application component compₖ using the buffer Bufferⱼ in state Stateₖ₋₁ finishes. In case the current state Stateₖ₋₁ is the final state State_{K}, the transition condition may, for example, require that the buffer Bufferⱼ is in the final state for a minimum time period.

The present method may thus enable an asynchronous handling of the buffers Buffer₁ through Buffer_{M}, which may reduce dependencies between components drastically and increase the robustness of the software system. In particular, the sequence of buffer working steps may be preserved automatically by the buffer states in the buffer manager, waiting times may be reduced in comparison to synchronous approaches and variable number of buffers and buffer sizes may be far easier to realize.

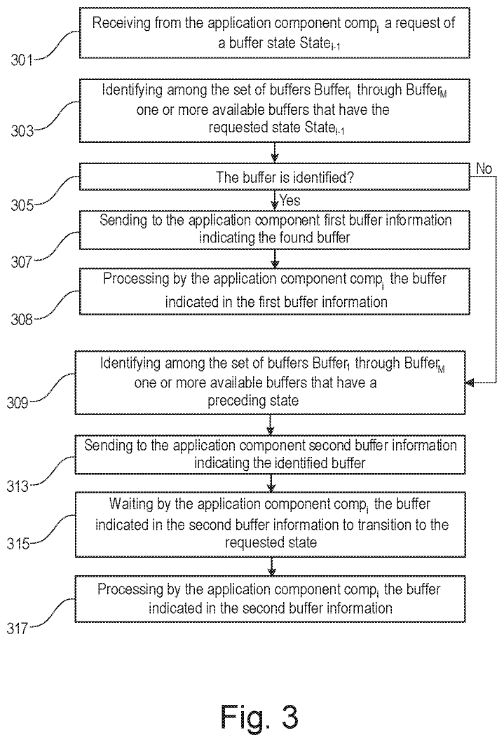

FIG. 3 is a flowchart for executing an application component in accordance with an example of the present subject matter. For the purpose of explanation, the method described in FIG. 3 may be implemented in the system illustrated in FIG. 1, but is not limited to this implementation.

The buffer manager 103 may receive in step 301 from the application component compᵢ a request of a buffer state Stateᵢ₋₁ representing the output required by the application component compᵢ.

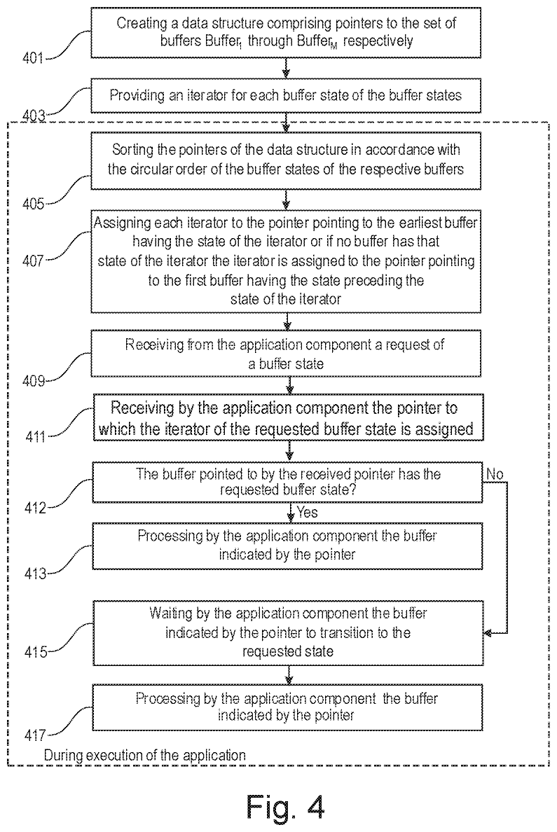

In response to receiving the request, the buffer manager 103 may identify or determine in step 303 among the set of buffers Buffer₁ through Buffer_{M} one or more buffers that have the requested state Stateᵢ₋₁ and which are available. E.g., it may happen that a buffer is in the requested state Stateᵢ₋₁ but it is not available as it is being used by another instance of the application component compᵢ. The buffer manager may, for example, identify the one or more buffers that have the requested state Stateᵢ₋₁ by using means such as iterators on a data structure that represents the buffers (cf. FIG. 4).

In case (305) one or more buffers having the state Stateᵢ₋₁ and available are identified by the buffer manager 103, the buffer manager 103 may send in step 307 first buffer information to the application component compₜ as follows. In case more than one buffer is found in step 303, the first buffer information may indicate the earliest buffer that has been in the requested state Stateᵢ₋₁. In case only one buffer is found in step 303, the first buffer information may indicate that buffer. The application component compᵢ may process in step 308 the buffer indicated in the first buffer information. Processing the buffer by the application component compᵢ means that the application component compᵢ is reading and/or writing data to the buffer.

In case (305) no buffer is available in the state Stateᵢ₋₁, the buffer manager 103 may identify in step 309 among the set of buffers Buffer₁ through Buffer_{M} for one or more buffers that are available and have a selected state which is a closest preceding state of the requested state.

The buffer manager 103 may send in step 313 second buffer information to the application component compᵢ as follows. In case more than one buffer is found in step 309, the second buffer information may indicate the first or earliest buffer that has transitioned to the selected state. In case only one buffer is found in step 309, the second buffer information may indicate that buffer. The application component compᵢ may wait in step 315 for the buffer to have the requested state Stateᵢ₋₁ and only then process the buffer in step 317.

FIG. 4 is a flowchart for executing an application in accordance with an example of the present subject matter. For the purpose of explanation, the method described in FIG. 4 may be implemented in the system illustrated in FIG. 1, but is not limited to this implementation.

A data structure comprising pointers to the set of buffers Buffer₁ through Buffer_{M} respectively may be created in step 401. The data structure may comprise M elements associated with the set of buffers Buffer₁ through Buffer_{M} respectively.

An iterator may be provided in step 403 for each buffer state of the buffer states. Each iterator is configured to traverse the data structure elements comprising the pointers that represent the state of the iterator.

During the execution of the application, steps 405 to 417 may be performed.

The pointers of the data structure may be sorted in step 405 in accordance with the circular order of the buffer states of the respective buffers. And in case more than one buffer is in the same state, the pointers of said more than one buffer may be sorted according to the time at which the buffers transitioned to said state.

The iterator is assigned in step 407 to the pointer pointing to the earliest buffer having the state of the iterator or if no buffer has that state of the iterator the iterator is located at the pointer pointing to the first buffer having the state preceding the state of the iterator.

A request of a buffer state representing the output required by the application component may be received in step 409.

The application component may receive in step 411 the pointer to which the iterator of the requested state is assigned.

In case (412) the buffer pointed to by the received pointer has the requested buffer state, the application component may process the buffer in step 413.

In case (412) the buffer pointed to by the received pointer is a first buffer having the state preceding the requested state, the application component waits in step 415 until that buffer has the requested state in order to execute in step 417 the application component.

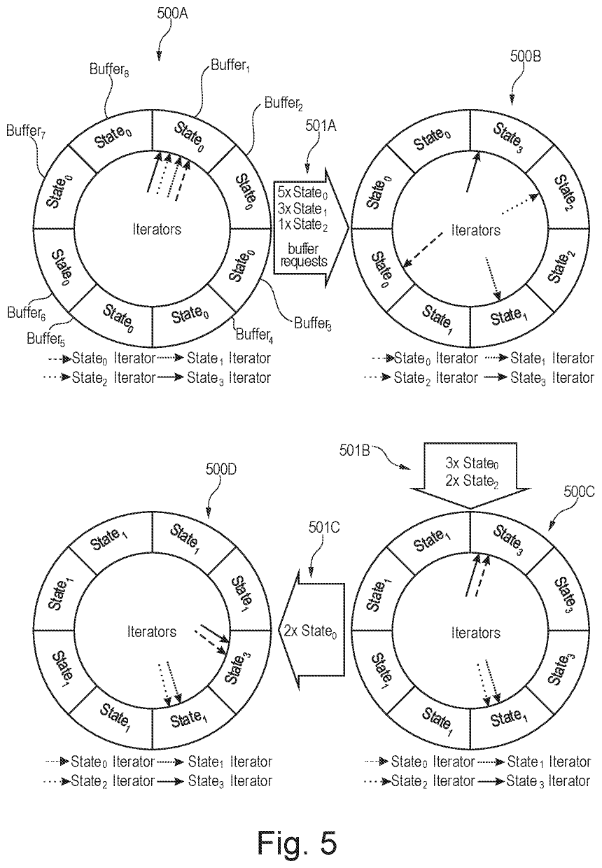

FIG. 5 is a diagram illustrating state changes and movement of iterators in accordance with an example of the present subject matter. FIG. 5 shows the status of a set of eight buffers Buffer₁ through Buffer₈ in four different stages of the execution of an application comprising three components comp₁, comp₂ and comp₃. As shown in FIG. 5 four buffer states are defined, namely State₀, State₁, State₂ and State₃. The application component comp₁ may be configured to process the buffer having the state State₀, comp₂ may be configured to process the buffer having the state State₁ and comp₃ may be configured to process the buffer having the state State₂. The final state State₃ may be the state representing the output of the component comp₂ after the component comp₃ has finished processing the buffer with state State₂ e.g., State₃ may be the keep-a-live state. As shown in FIG. 5, each state of the states is associated with a respective iterator indicated by the arrows. The four iterators may be referred to herein as State₀ iterator, State₁ iterator, State₂ iterator and State₃ iterator.

Before execution of the application, the eight buffers Buffer₁ through Buffer₈ are assigned at stage 500A the initial state State₀. At this stage, all iterators are initially assigned to the pointer of the buffer Buffer₁. The application may be repeatedly executed after stage 500A.

During the execution of the application, five first requests of the buffers having state State₀, three second requests of the buffers having state State₁ and one third request of the buffer having state State₃ may be received at stage 501A by the buffer manager. The first requests may be sent by respective instances of the first component compₗ. The second requests may be sent by respective instances of the second component comp₂. The third requests may be sent by respective instances of the third component comp₃.

Immediately after receiving the requests, the first requests may be assigned the buffers Buffer₁ through Buffer₅ respectively. The remaining buffers Buffer₆ through Buffer₈ remain in the initial state as they are not assigned. This means that the five buffers Buffer₁ through Buffer₅ would be processed by the component comp₁. For that, the current pointer of the State₀ iterator (which is in Buffer₁) may be sent to the first instance the component comp₁ so that component comp₁ may process the buffer Buffer₁, and then the iterator may be advanced in order to be assigned to the pointer of the buffer Buffer₂. The current pointer of the State₀ iterator (which is in Buffer₂) may be sent to the second instance of the component comp₁ so that component comp₁ may process the buffer Buffer₂ and so on. Upon finishing the processing of each buffer of the buffers Buffer₁ through Buffer₅ by the component comp₁, the state of the buffer changes to the subsequent state State₁. For example, Buffer₁ may be the first buffer that transitioned to the state State₁, Buffer₂ may be the second buffer that transitioned to the state State₁, and Buffer₃ may be the third buffer that transitioned to the state State₁.

As soon as a buffer of the buffers Buffer₁ through Buffer₅ transitions to the state State₁, the buffer may be assigned to one of the second requests. This may result in the buffers Buffer₁ through Buffer₃ being processed by the respective instances of the component comp₂. Upon finishing the processing of the buffers Buffer₁ through Buffer₃ by the component comp₂, the state of each of the buffers Buffer₁ through Buffer₃ changes to the subsequent state State₂. Thus, one of the three buffers Buffer₁ through Buffer₃ in state State₂, namely Buffer₁, may be assigned to the third request. Upon finishing the processing of the buffer Buffer₁ by the component comp₃, the state of the buffer Buffer₁ changes to the subsequent state State₃. This resulting status of the buffers is shown in stage 500B of FIG. 5. At stage 500B, the State₀ iterator is pointing to buffer Buffer₆, the State₁ iterator is pointing to buffer Buffer₄ which is the first buffer of the two buffers Buffer₄ and Buffer₅ that transitioned to the state State₁, the State₂ iterator is pointing to buffer Buffer₂ which is the first buffer of the two buffers Buffer₂ and Buffer₃ that transitioned to the state State₃ and the State₃ iterator is pointing to buffer Buffer₁ which is the only buffer having the state State₃.

After the stage 500B, additional three first requests of the buffers having state State₀ and two third requests of the buffers having state State₂ may be received at 501B by the buffer manager. The iterators may be processed as described above in order to serve the requests. The three first requests may be assigned the buffers Buffer₆ through Buffer₈ respectively as they are in the initial state State₀. The initial state of the buffers Buffer₆ through Buffer₈ is changed to the state State₁ after the component comp₁ finishes processing of said buffers. The two third requests may be assigned the buffers Buffer₂ through Buffer₃ respectively as they are in the state State₂. The state State₂ of the buffers Buffer₂ through Buffer₃ is changed to the state State₃ after the component comp₃ finishes processing of said buffers. The resulting status of the buffers after completion of executions of the additional requests is shown in stage 500C of FIG. 5. At stage 500C, the State₀ iterator is pointing to buffer Buffer₁ having the state State₃ (which immediately precedes state State₀) because none of the buffers is in state State₀. The State₃ iterator is pointing to the same buffer Buffer₁. Similarly, the State₂ iterator is pointing to buffer Buffer₄ having the state State₁ (which immediately precedes state State₂) because none of the buffers is in state State₂. The State₁ iterator is pointing to the same buffer Buffer₄.

After the stage 500C, additional two first requests of the buffers having state State₀ may be received at 501C by the buffer manager. The iterators may be processed as described above in order to serve the requests. However, none of the buffers Buffer₁ through Buffer₈ is in state State₀. This means that the first instance of the component comp₁ would receive a pointer to the buffer Buffer₁ which is in state State₃ and has to wait for the buffer Buffer₁ to transition to state State₀. The State₀ iterator would be advanced to the next buffer Buffer₂ having the state State₃ because there is no buffer with state State₀. State₃ iterator would be advanced to the next buffer Buffer₂ of state State₃. The second instance of component comp₁ would receive a pointer to the buffer Buffer₂ which is in state State₃ and has to wait for the buffer Buffer₂ to transition to state State₀.

After the states of the buffers Buffer₁ and Buffer₂ have transitioned to state State₀ and the component comp₁ finishes the processing of the buffers Buffer₁ and Buffer₂, the state of the two buffers Buffer₁ and Buffer₂ may be changed to state State₁. This is shown in stage 500D. In addition, the State₀ iterator and State₃ iterator would be advanced to the next buffer Buffer₃ having the state State₃.

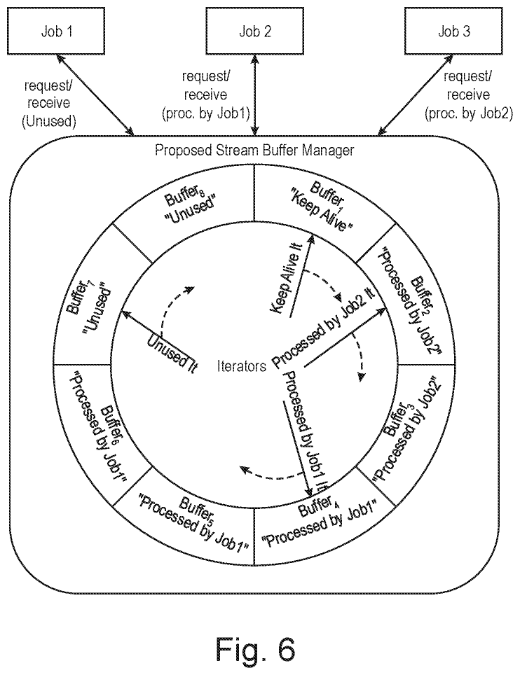

FIG. 6 is a diagram illustrating state changes and movement of iterators in accordance with an example of the present subject matter. In this example, the buffer states may be equivalently be referred to as process states. For example, each buffer state Stateₖ, where k>1, is associated with a specific content of the buffer. This may be equivalent to say that the buffer state Stateₖ, where k>1, is associated with the respective application component compₖ₊₁ processing the buffer having that state Stateₖ.

FIG. 6 shows the status of a set of eight buffers Buffer₁ through Buffer₈, wherein the buffer states comprise five states. The different states a buffer goes through are: State₀ may refer to an unused buffer. State₁ may refer to a process (job1) for populating a buffer with data (e.g., by receiving the data from a TCP/IP socket). State₂ may refer to a process (job2) that does data processing/transformations. State₃ may refer to a process (job3) for writing the buffer data to a named pipe and State₄ may refer to the process (job4) of keeping the buffer's data alive. The buffer manager may ensure that there will be at least 5 buffers in the ‘keep alive’ state. So, if job2 needs a new buffer and there are less than 5 ‘keep alive’ buffers available, job2 has to wait until job3 finished processing another buffer and set it to state ‘keep alive’, increasing the number of buffers in the final state. When the number exceeds the threshold, job2 retrieves the oldest ‘keep alive’ buffer, set its state to state State₀ (‘unused’) and populate it with data.

The diagram also shows some special cases. First-up, it may not happen that an iterator (it) of higher state passes an iterator of lower state by design. The buffers are requested in a strict order from the needing components/jobs and wait, until the buffer reaches the state needed. So, it may be important, that there is a strict order of states and no possible skips may be here. The only possible option, where an iterator draws another iterator with it, may be when the iterator of the initial state (in FIG. 5 State₀) needs to pass the iterator of the last state (in FIG. 5 State₃, above also mentioned as ‘keep alive’ state). This special case is permitted, as it allows the buffer manager to recycle the oldest buffers, which are just kept alive for information preserving reasons. The information preserving may be highly efficient, as no additional steps, memory allocations of data copies must be done and despite that the internal data are stored as long as possible, usable for debug or informative purposes. To not overwrite all preserved data, there may be some configuration steps to be done.

The minimum number of buffers in the last (‘keep alive’) state may be checked, before the first iterator is allowed to recycle corresponding buffers. This is needed to always preserve a number of current data and can easily be checked, if there is a request for a buffer in the initial state. In this case, the number of buffers in the last state is compared with the configured minimum number of buffers in the last state and if the first number is higher, the oldest buffer gets transitioned to the initial state, notifying all components/jobs that might be already waiting for a new buffer in initial state. By the nature of the circular internal structure the oldest data is recycled first. Other configurable parameters can be the number and size of buffers, which is needed by the buffer manager during initialization, as it may also be responsible for creating the buffers at the beginning. In case a reset of the buffer manager is requested, it may just reset every buffer to the initial state and every iterator to the same first buffer. Before this happens, the buffer manager may have to wait, until all buffers have reached the initial or last state, so none is in the middle of a lifecycle and potential data losses could occur.

The present subject matter may comprise the following clauses.

Clause 1. A method for execution of an application using buffers, the application comprising a sequence of components, the first component of the sequence being configured to store output data in an unused buffer, each subsequent component of the sequence being configured to use a buffer comprising an output provided by the component preceding said subsequent component; the method comprising: providing a set of buffer states representing different contents of the buffer respectively, the set of buffer states comprising an initial state representing a content of the unused buffer and subsequent states representing the outputs of the sequence of components respectively, wherein the application component is configured to use the buffer in case the buffer is in the state representing the output required by the application component; sorting the buffer states in order of the sequence of components, wherein the sorting is circular so that a final state is followed by the initial state; assigning to the buffers the initial state before execution of the application; repeatedly executing the application; changing during execution of the application a current state of a buffer of the buffers to a subsequent state in case a transition condition is fulfilled, wherein the transition condition requires that the current application component using the buffer finishes.

Clause 2. The method of clause 1, wherein the final state represents the output of the second last component of the sequence.

Clause 3. The method of clause 1, wherein the final state represents the output of the second last component of the sequence after the last component of the sequence finishes.

Clause 4. The method of clause 3, wherein in case the current state is the final state, the transition condition further requires that the buffer having the current state is the first buffer of a minimum number of buffers having the final state.

Clause 5. The method of clause 3 or 4, wherein in case the current state is the final state, the transition condition further requires that the buffer having the current state remains in that final state for a minimum period of time or until it reaches a maximum size.

Clause 6. The method of any of the preceding clauses 3 to 5, further comprising using data stored in the buffer in the final state to perform debugging of the application.

Clause 7. The method of any of the preceding clauses 1 to 6, wherein the changing of the current state is performed by the current application component.

Clause 8. The method of clause 7, wherein each application component is configured to use an available buffer of a specific state or to wait for a buffer to become available in that specific state, the method further comprising notifying by the current application component the change to all application components which are waiting for a buffer.

Clause 9. The method of any of the preceding clauses 1 to 8, wherein executing the application component comprises: receiving by a buffer manager a request of a buffer state representing the output required by said application component; sending by the buffer manager an indication of an available buffer of said buffers that has the requested buffer state or a buffer that will next transition to that requested buffer state; and executing the application component using said indicated buffer or wait until the buffer has the requested state.

Clause 10. The method of any of the preceding clauses 1 to 9, further comprising: creating by the buffer manager a data structure comprising pointers to the buffers respectively; providing for each buffer state of the buffer states an iterator for traversing the data structure, each iterator being configured to traverse the data structure elements comprising the pointers that represent the state of the iterator; during the execution of the application: sorting by the buffer manager the pointers of the data structure in accordance with the circular order of the buffer states of the respective buffers, wherein in case more than one buffer is in the same state, sorting by the buffer manager the pointers of said more than one buffer according to the time at which the buffers transitioned to said state; wherein the iterator is assigned to the pointer pointing to the earliest buffer having the state of the iterator or if no buffer has that state of the iterator the iterator is assigned to the pointer pointing to the first buffer having the state preceding the state of the iterator; receiving by the buffer manager a request of a buffer state representing the output required by the application component; sending by the buffer manager to the application component the pointer at which the iterator of the requested state is located; in case the buffer pointed to by the received pointer has the requested buffer state executing the application component using the buffer; in case the buffer pointed to by the received pointer is the first buffer having the state preceding the requested state, the application component waits until that buffer has the requested state in order to execute the application component.

Clause 11. The method of clause 10, further comprising in response to receiving the pointer by the application component checking the state of the buffer associated with the pointer in order to determine whether the buffer pointed to by the received pointer has the requested buffer state.

Clause 12. The method of any of the preceding clauses 1 to 9, further comprising: creating by the buffer manager a data structure comprising pointers to the buffers respectively; providing for each buffer state of the buffer states an iterator for traversing the data structure, each iterator being configured to traverse the data structure elements comprising the pointers that represent the state of the iterator; during the execution of the application: sorting by the buffer manager the pointers of the data structure in accordance with the circular order of the buffer states of the respective buffers, wherein in case more than one buffer is in the same state, sorting the pointers of said more than one buffer according to the time at which the buffers transitioned to said state; wherein the iterator is assigned to the pointer pointing to the earliest buffer having the state of the iterator or if no buffer has that state of the iterator the iterator is assigned to the pointer pointing to the first buffer having the state preceding the state of the iterator; receiving a request of a buffer state representing the output required by the application component; identifying by the buffer manager the pointer at which the iterator of the requested state is located; in case the buffer pointed to by the pointer has the requested buffer state sending the pointer to the application component; in case the buffer pointed to by the pointer is a first buffer having the state preceding the requested state, waiting by the buffer manager until that buffer has the requested state in order to send by the buffer manager the pointer to the application component; executing the application component using the buffer pointed to by the received pointer.

Clause 13. The method of any of the preceding clauses 1 to 12, further comprising receiving a request to reset the buffers, setting the buffers to the initial state in case the buffers are in the initial state or final state, the setting comprising deleting data of the buffers.

Clause 14. The method of any of the preceding clauses 1 to 13, the buffer states being encoded in the respective buffers.

Clause 15. The method of any of the preceding clauses 1 to 14, wherein execution of the application is repeated until a stopping criterion is fulfilled, wherein the stopping criterion requires a maximum number of repetitions or a stopping request is received.

Clause 16. The method of any of the preceding clauses 1 to 15, the application being a data streaming application or monitoring application.

Computing environment 800 contains an example of an environment for the execution of at least some of the computer code involved in performing the inventive methods, such as a buffer assisted application processing code 900. In addition to block 900, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 900, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

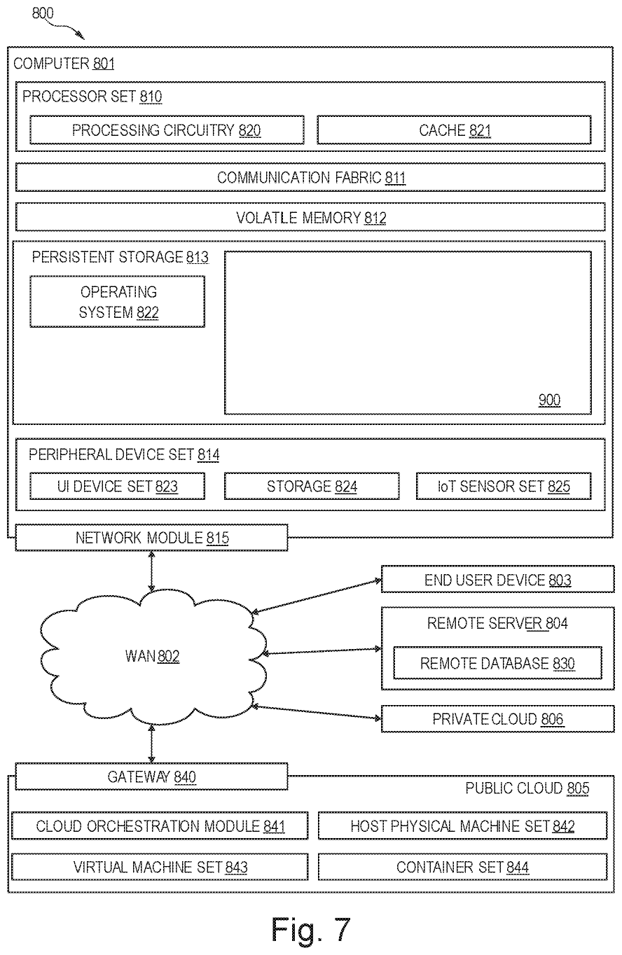

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 7. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 900 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 900 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

What is claimed is:

1. A method for execution of an application using buffers, the application comprising a sequence of components, the first component of the sequence being configured to store output data in an unused buffer, each subsequent component of the sequence being configured to use a buffer comprising an output provided by the component preceding said subsequent component, the method comprising:
providing a set of buffer states representing different contents of the buffer respectively, the set of buffer states comprising an initial state representing a content of the unused buffer and subsequent states representing the outputs of the sequence of components respectively, wherein the application component is configured to use the buffer in case the buffer is in the state representing the output required by the application component;
sorting the buffer states in order of the sequence of components, wherein the sorting is circular so that a final state is followed by the initial state;
assigning to the buffers the initial state before execution of the application;
repeatedly executing the application; and
changing during execution of the application a current state of a buffer of the buffers to a subsequent state in case a transition condition is fulfilled, wherein the transition condition requires that a current application component using the buffer finishes.

2. The method of claim 1, wherein the final state represents the output of the second last component of the sequence.

3. The method of claim 1, wherein the final state represents the output of the second last component of the sequence after the last component of the sequence finishes.

4. The method of claim 3, wherein the transition condition further requires that the buffer having the current state is the first buffer of a minimum number of buffers having the final state.

5. The method of claim 3, wherein the transition condition further requires that the buffer having the current state remains in that final state for a minimum period of time or until it reaches a maximum size.

6. The method of claim 3, the method further comprising:
using data stored in the buffer in the final state to perform debugging of the application.

7. The method of claim 1, wherein the changing of the current state is performed by the current application component.

8. A computer program product for execution of an application using buffers, the application comprising a sequence of components, the first component of the sequence being configured to store output data in an unused buffer, each subsequent component of the sequence being configured to use a buffer comprising an output provided by the component preceding said subsequent component, the computer program product comprising:
one or more computer-readable storage media and program instructions stored on the one or more computer-readable storage media, the program instructions comprising:
program instructions to provide a set of buffer states representing different contents of the buffer respectively, the set of buffer states comprising an initial state representing a content of the unused buffer and subsequent states representing the outputs of the sequence of components respectively, wherein the application component is configured to use the buffer in case the buffer is in the state representing the output required by the application component;
program instructions to sort the buffer states in order of the sequence of components, wherein the sorting is circular so that a final state is followed by the initial state;
program instructions to assign to the buffers the initial state before execution of the application;
program instructions to repeatedly execute the application; and
program instructions to change during execution of the application a current state of a buffer of the buffers to a subsequent state in case a transition condition is fulfilled, wherein the transition condition requires that a current application component using the buffer finishes.

9. The computer program product of claim 8, wherein the final state represents the output of the second last component of the sequence.

10. The computer program product of claim 8, wherein the final state represents the output of the second last component of the sequence after the last component of the sequence finishes.

11. The computer program product of claim 10, wherein the transition condition further requires that the buffer having the current state is the first buffer of a minimum number of buffers having the final state.

12. The computer program product of claim 10, wherein the transition condition further requires that the buffer having the current state remains in that final state for a minimum period of time or until it reaches a maximum size.

13. The computer program product of claim 10, the program instructions further comprising:
program instructions to use data stored in the buffer in the final state to perform debugging of the application.

14. The computer program product of claim 8, wherein the changing of the current state is performed by the current application component.

15. A computer system for execution of an application using buffers, the application comprising a sequence of components, the first component of the sequence being configured to store output data in an unused buffer, each subsequent component of the sequence being configured to use a buffer comprising an output provided by the component preceding said subsequent component, the computer system comprising:
one or more computer processors;
one or more computer readable storage media; and
program instructions stored on the computer readable storage media for execution by at least one of the one or more processors, the program instructions comprising:
program instructions to provide a set of buffer states representing different contents of the buffer respectively, the set of buffer states comprising an initial state representing a content of the unused buffer and subsequent states representing the outputs of the sequence of components respectively, wherein the application component is configured to use the buffer in case the buffer is in the state representing the output required by the application component;
program instructions to sort the buffer states in order of the sequence of components, wherein the sorting is circular so that a final state is followed by the initial state;
program instructions to assign to the buffers the initial state before execution of the application;
program instructions to repeatedly execute the application; and
program instructions to change during execution of the application a current state of a buffer of the buffers to a subsequent state in case a transition condition is fulfilled, wherein the transition condition requires that a current application component using the buffer finishes.

16. The computer system of claim 15, wherein the final state represents the output of the second last component of the sequence.

17. The computer system of claim 15, wherein the final state represents the output of the second last component of the sequence after the last component of the sequence finishes.

18. The computer system of claim 17, wherein the transition condition further requires that the buffer having the current state is the first buffer of a minimum number of buffers having the final state.

19. The computer system of claim 17, wherein the transition condition further requires that the buffer having the current state remains in that final state for a minimum period of time or until it reaches a maximum size.

20. The computer system of claim 17, the program instructions further comprising:
program instructions to use data stored in the buffer in the final state to perform debugging of the application.
